(19) United States
(12) Patent Application Publication
(10) Pub. No.: US 2025/0151026 A1
(43) Pub. Date: May 8, 2025

(54) NOTIFICATION PROCESSING METHOD AND APPARATUS, NOTIFICATION METHOD AND APPARATUS, TERMINAL, AND NETWORK SIDE DEVICE

(71) Applicant: VIVO MOBILE COMMUNICATION CO., LTD., Dongguan (CN)

(72) Inventor: Jiamin LIU, Dongguan (CN)

(73) Assignee: VIVO MOBILE COMMUNICATION CO., LTD., Dongguan (CN)

(21) Appl. No.: 19/019,228

(22) Filed: Jan. 13, 2025

Related U.S. Application Data
(63) Continuation of application No. PCT/CN2023/104946, filed on Jun. 30, 2023.

(30) Foreign Application Priority Data
Jul. 15, 2022 (CN) 202210836820.9

(51) Int. Cl. H04W 68/00; H04W 4/06; H04W 72/232; H04W 72/30

(52) U.S. Cl. CPC H04W 68/00; H04W 4/06; H04W 72/232; H04W 72/30

(57) ABSTRACT

A notification processing method and a terminal are provided. The notification processing method includes: receiving, by the terminal, a first notification. The first notification is used to notify at least one of that a configuration of a multicast service changes or the multicast service ends. That the multicast service ends includes at least one of the following: sending of the multicast service ends or receiving of the multicast service ends. The multicast service is a multicast service that is being received by the terminal. The notification processing method further includes executing, by the terminal, a response operation of the first notification.

### CROSS-REFERENCE TO RELATED APPLICATIONS

This application is a continuation of International Application No. PCT/CN2023/104946, filed on Jun. 30, 2023, which claims priority to Chinese Patent Application No. 202210836820.9, filed on Jul. 15, 2022. The entire contents of each of the above-referenced applications are expressly incorporated herein by reference.

### TECHNICAL FIELD

This application pertains to the field of communication technologies, and specifically relates to a notification processing method and apparatus, a notification method and apparatus, a terminal, and a network side device.

### BACKGROUND

Some communication systems support transmission of a multicast service. For example, a terminal can receive a multicast service in a connected state (Connected). However, at present, the terminal cannot determine whether a configuration of the multicast service changes, and cannot determine whether the multicast service ends, but either of the two may affect an effect of receiving the multicast service by the terminal. It can be learned that currently, the effect of receiving the multicast service by the terminal is relatively poor.

### SUMMARY

Embodiments of this application provide a notification processing method and apparatus, a notification method and apparatus, a terminal, and a network side device.

According to a first aspect, a notification processing method is provided, including:
receiving, by a terminal, a first notification, where the first notification is used to notify at least one of that a configuration of a multicast service changes and the multicast service ends, where the multicast service is a multicast service that is being received by the terminal, and that the multicast service ends includes at least one of the following: sending of the multicast service ends or receiving of the multicast service ends; and
executing, by the terminal, a response operation of the first notification.

According to a second aspect, a notification method is provided, including:
sending, by a network side device, a first notification to a terminal, where the first notification is used to notify at least one of that a configuration of a multicast service changes and the multicast service ends, where the multicast service is a multicast service that is being received by the terminal, and that the multicast service ends includes at least one of the following: sending of the multicast service ends or receiving of the multicast service ends.

According to a third aspect, a notification processing apparatus is provided, including:
a first receiving module, configured to receive a first notification, where the first notification is used to notify at least one of that a configuration of a multicast service changes and the multicast service ends, where the multicast service is a multicast service that is being received by a terminal, and that the multicast service ends includes at least one of the following: sending of the multicast service ends or receiving of the multicast service ends; and
an execution module, configured to execute a response operation of the first notification.

According to a fourth aspect, a notification apparatus is provided, including:
a first sending module, configured to send a first notification to a terminal, where the first notification is used to notify at least one of that a configuration of a multicast service changes and the multicast service ends, where the multicast service is a multicast service that is being received by the terminal, and that the multicast service ends includes at least one of the following: sending of the multicast service ends or receiving of the multicast service ends.

According to a fifth aspect, a terminal is provided. The terminal includes a processor and a memory, the memory stores a program or an instruction that can be run on the processor, and the program or the instruction is executed by the processor to implement the steps of the notification processing method provided in the embodiments of this application.

According to a sixth aspect, a terminal is provided, including a processor and a communication interface. The communication interface is configured to receive a first notification, where the first notification is used to notify at least one of that a configuration of a multicast service changes and the multicast service ends, where the multicast service is a multicast service that is being received by the terminal, and that the multicast service ends includes at least one of the following: sending of the multicast service ends or receiving of the multicast service ends; and the processor or the communication interface is configured to execute a response operation of the first notification.

According to a seventh aspect, a network side device is provided, including a processor and a memory. The memory stores a program or an instruction that can be run on the processor, and the program or the instruction is executed by the processor to implement the steps of the notification method provided in the embodiments of this application.

According to an eighth aspect, a network side device is provided, including a processor and a communication interface. The communication interface is configured to send a first notification to a terminal, where the first notification is used to notify at least one of that a configuration of a multicast service changes and the multicast service ends, where the multicast service is a multicast service that is being received by the terminal, and that the multicast service ends includes at least one of the following: sending of the multicast service ends or receiving of the multicast service end.

According to a ninth aspect, a readable storage medium is provided. The readable storage medium stores a program or an instruction, and the program or the instruction is executed by a processor to implement the steps of the notification processing method provided in the embodiments of this application, or the program or the instruction is executed by a processor to implement the steps of the notification method provided in the embodiments of this application.

According to a tenth aspect, a chip is provided. The chip includes a processor and a communication interface, the communication interface is coupled to the processor, and the processor is configured to run a program or an instruction to implement the notification processing method provided in the embodiments of this application, or the processor is configured to run a program or an instruction to implement the notification method provided in the embodiments of this application.

According to an eleventh aspect, a computer program/program product is provided. The computer program/program product is stored in a storage medium, and the computer program/program product is executed by at least one processor to implement the notification processing method provided in the embodiments of this application, or the computer program/program product is executed by at least one processor to implement the notification method provided in the embodiments of this application.

According to a twelfth aspect, a wireless communication system is provided, including a terminal and a network side device. The terminal may be configured to perform the steps of the notification processing method provided in the embodiments of this application, and the network side device may be configured to perform the steps of the notification method provided in the embodiments of this application.

In the embodiments of this application, a terminal receives a first notification, where the first notification is used to notify at least one of that a configuration of a multicast service changes and the multicast service ends, where that the multicast service ends includes at least one of the following: sending of the multicast service ends or receiving of the multicast service ends, and the multicast service is a multicast service that is being received by the terminal; and the terminal executes a response operation of the first notification. In this way, the terminal can learn at least one of that the configuration of the multicast service changes and the multicast service ends, thereby improving an effect of receiving the multicast service by the terminal.

### BRIEF DESCRIPTION OF DRAWINGS

FIG. 1 is a block diagram of a wireless communication system to which the embodiments of this application can be applied;

FIG. 2 is a flowchart of a notification processing method according to an embodiment of this application;

FIG. 3 is a flowchart of a notification method according to an embodiment of this application;

FIG. 4 is a structural diagram of a notification processing apparatus according to an embodiment of this application;

FIG. 5 is a structural diagram of a notification apparatus according to an embodiment of this application;

FIG. 6 is a structural diagram of a communication device according to an embodiment of this application;

FIG. 7 is a structural diagram of a terminal according to an embodiment of this application; and

FIG. 8 is a structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

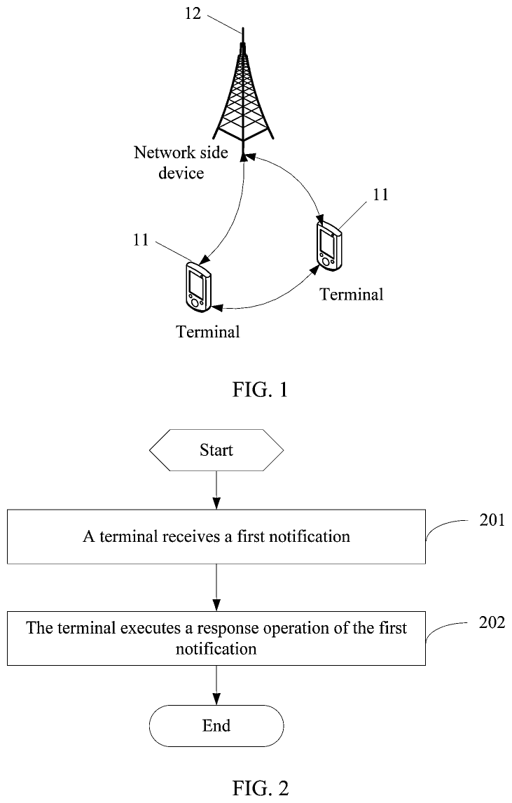

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The network side device 12 may also be referred to as a radio access network device, a Radio Access Network (RAN), a radio access network function, or a radio access network unit. The network side device 12 may include a base station, a Wireless Local Area Network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission and Reception Point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

With reference to the accompanying drawings, the following describes in detail a notification processing method and apparatus, a notification method and apparatus, a terminal, and a network side device provided in the embodiments of this application by using some embodiments and application scenarios thereof.

Referring to FIG. 2, FIG. 2 is a flowchart of a notification processing method according to an embodiment of this application. As shown in FIG. 2, the method includes the following steps:

201. A terminal receives a first notification, where the first notification is used to notify at least one of that a configuration of a multicast service changes and the multicast service ends, where the multicast service is a multicast service that is being received by the terminal, and that the multicast service ends includes at least one of the following: sending of the multicast service ends or receiving of the multicast service ends.

The first notification may be a notification sent by a network side device and received by the terminal. This is not limited in this embodiment of this application. For example, the terminal may receive the first notification sent by another terminal.

In this embodiment of this application, the configuration of the multicast service may include but is not limited to a Multicast/Broadcast Service Radio Bear (MRB) configuration, a time domain pattern, a frequency domain resource, dynamic scheduling information, and the like. The time domain pattern may include configurations such as a period length, a period start location, and activation duration in a period.

That the configuration of the multicast service changes may be that some or all configurations change.

That sending of the multicast service ends may be understood as that sending the multicast service by the network side device ends, and that receiving of the multicast service ends may be understood as that receiving the multicast service by the terminal ends. In some implementations, only that sending of the multicast service ends or receiving of the multicast service ends may be notified. In some implementations, that sending of the multicast service ends or receiving of the multicast service ends may be notified.

In some implementations, the multicast service is a multicast service that is being received by the terminal in an inactive state. In this way, the terminal can receive the multicast service in an inactive state. Network load of the terminal in an inactive state is less than network load of the terminal in a connected state, thereby reducing network load.

In this embodiment of this application, the multicast service may be represented as a multicast service, or may be represented as a Multicast/Broadcast Service (MBS).

202. The terminal executes a response operation of the first notification.

The response operation may be determined based on a protocol stipulation, may be determined based on implementation of the terminal, or may be determined based on a configuration on a network side, for example, entering a connected state, release a resource, and requesting a new configuration.

In this embodiment of this application, through the foregoing step, at least one of that the configuration of the multicast service changes and the multicast service ends can be learned, to avoid a receiving error caused by continuing to receive the multicast service by using the original configuration because the terminal cannot learn that the configuration of the multicast service ends, or avoid excessive power consumption caused by continuing to receive the multicast service because the terminal cannot learn that the multicast service ends, thereby improving an effect of receiving the multicast service by the terminal.

In an implementation, the response operation includes at least one of the following:
initiating connection resumption to a network side device;
requesting the changed new configuration of the multicast service from the network side device;
receiving the changed new configuration that is of the multicast service and that is sent to the network side device;
releasing the multicast service;
releasing to an idle state; and
remaining in an inactive state.

The connection resumption is initiated to the network side device, so that the terminal can enter a connected state. In this way, in a case that the configuration of the multicast service changes, the multicast service is directly received in a connected state.

It should be noted that after the changed new configuration of the multicast service is requested from the network side device, the network side may return the new configuration to the terminal or do not return the new configuration based on information learned by the network side. For example, in some cases, the network side device may instruct the terminal to enter a connected state to directly receive the multicast service in a connected state.

After the changed new configuration that is of the multicast service and that is sent to the network side device is received, the multicast service may be received in an inactive state.

The releasing the multicast service may be releasing at least one of a bearer and the configuration of the multicast service, so as to save resources.

The releasing to an idle state can save power consumption of the terminal, or can avoid a cumbersome process of releasing after connection resumption.

The remaining in an inactive state can avoid a cumbersome process of releasing after connection resumption.

In some implementations, in a case that the first notification indicates that the configuration of the multicast service changes, the response operation includes at least one of the following:
initiating connection resumption to the network side device;
requesting the changed new configuration of the multicast service from the network side device;
receiving the changed new configuration that is of the multicast service and that is sent to the network side device; and
remaining in an inactive state.

In this implementation, in a case that the configuration of the multicast service changes, the multicast service may be received in a connected state or the multicast service continues to be received in an inactive state, so that the terminal can receive more multicast service content in a timely manner.

In some implementations, in a case that the first notification indicates that the multicast service ends, the response operation includes at least one of the following:
releasing the multicast service;
releasing to an idle state; and
remaining in an inactive state.

In this implementation, in a case that the multicast service ends, the multicast service may be released to save resources; in a case that the multicast service ends, releasing to an idle state is performed to save power consumption of the terminal or avoid a cumbersome process of releasing after connection resumption; or in a case that the multicast service ends, remaining in an inactive state is performed to avoid a cumbersome process of releasing after connection resumption.

In some implementations, after the initiating connection resumption to the network side device, the method further includes at least one of the following:
receiving, by the terminal, a connection resume message;
receiving, by the terminal, a Radio Resource Control (RRC) release message; and
receiving, by the terminal, the changed new configuration of the multicast service.

The terminal enters a connected state through the connection resume message.

The RRC release message may enable the terminal to return to an idle state, or may carry the changed new configuration of the multicast service. For example, in a case that the first notification indicates that the configuration of the multicast service changes, the RRC release message carries the changed new configuration of the multicast service, so that the terminal can continue to receive the multicast service in an inactive state.

The receiving, by the terminal, the changed new configuration of the multicast service may be receiving the changed new configuration that is of the multicast service and that is sent by the network side device by using a message other than the RRC release message, so that the terminal can continue to receive the multicast service in an inactive state.

In an implementation, the first notification includes at least one of the following:
a paging message, Layer 1 (L1) signaling, Medium Access Control (MAC) signaling, an RRC message, and common signaling.

In some implementations, the paging message may include at least one of the following:
a first paging message that carries a User Equipment Identifier (UE ID); and
a second paging message that carries a Temporary Mobile Group Identity (TMGI).

The first paging message that carries a terminal identifier may be understood as a paging message for paging by using the terminal identifier, and the second paging message that carries a TMGI may be understood as a paging message for paging by using the TMGI.

The terminal identifier may be a S-Temporary Mobile Subscriber Identity (S-TMSI) or an Inactive-Radio Network Temporary Identity (I-RNTI).

The TMGI may be a service identity of the multicast service.

The first paging message may indicate at least one of that the configuration of the multicast service changes and the multicast service ends, and the second paging message may indicate at least one of that the configuration of the multicast service changes and the multicast service ends; or the first paging message may indicate one of that the configuration of the multicast service changes and the multicast service ends, and the second paging message may indicate the other of that the configuration of the multicast service changes and the multicast service ends.

In this implementation, at least one of that the configuration of the multicast service changes and the multicast service ends is notified by using a paging message, so that the terminal can learn, in a timely manner, at least one of that the configuration of the multicast service changes and the multicast service ends.

An embodiment is as follows:

A multicast service cell needs to notify a terminal in a non-connected state that a configuration of a multicast service changes or the service ends due to a change of a situation. Paging is a feasible manner of notifying the terminal. For example, the following manner may be used:

Manner 1: Paging is performed by using a terminal identifier (Paging by UE ID).

When the configuration of the multicast service changes or the service ends, a UE ID may be used to page a terminal. Each receiving terminal of the multicast service is managed by a network side. The terminal performs a process of joining the multicast service to a core network, and the core network sends terminal information to an access network. Therefore, a network side device knows which terminals are interested in the multicast service. In addition, the network side device finally decides to release some terminals to an inactive state (Inactive) to receive the multicast service. Therefore, for a cell in which the multicast service is located, a list of receiving terminals in an inactive may be stored. When the configuration of the multicast service is ready to change or the service ends, paging is directly performed by using each UE ID in the stored list to find each terminal.

A paging range may be a Radio Access Network (RAN) paging area of each UE, that is, an RNA range.

In another implementation, because the configuration of the multicast service is generally valid in a single cell or in an area, the terminal may be paged only in the multicast cell or in a range of the valid area of the configuration. To prevent the terminal from camping in another cell covered by the multicast cell and receiving a multicast service in the multicast cell, a paging message is sent to another overlapping or neighboring coverage cell of the multicast cell, or a cell located in an RNA range of the terminal in the foregoing cell.

In particular, in the paging message, a multicast update purpose may be further distinguished, that is, one piece of indication information is carried, where the indication information is used to indicate the multicast update purpose, and corresponds to a UE ID or a TMGI. For example, the multicast service changes or the service ends or a common paging manner is used for the service change, and a special flag for the end of the service is carried. Because the service change is to perform connection resumption, which is basically consistent with behavior that common downlink data arrives at paging, the service may be directly released when ending, so as to avoid releasing after the connection resumption. In addition, the terminal learns that the service ends, and an MRB may be released.

In the foregoing paging manner, if the terminal is still within a receiving range of the multicast cell or the valid range of the configuration, the terminal may receive a paging message about the UE ID of the terminal, where the UE ID may be an I-RNTI, an S-TMSI, or the like, or may be a new ID, and is used to indicate that this paging is performed for which the multicast service changes. If a matched new ID is received, the terminal restores connection establishment.

Manner 2: Paging is performed by using a TMGI (Paging by TMGI):

The paging by TMGI manner means that a paging message does not carry a UE ID, but carries a service identity TMGI. In this way, a plurality of terminals interested in the TMGI may not send different UE IDs, and a uniform TMGI identity may be used to wake all terminals interested in the service.

The network side device knows a list of terminals interested in this multicast service, and a paging range may be a RAN paging area of each terminal, that is, an RNA range. For a paging moment of each terminal, if there is an overlapping part, the TMGI is sent once.

In another implementation, because the configuration of the multicast service is generally valid in a single cell or in an area, the terminal list may be paged only in the multicast cell or in a range of the valid area of the configuration. To prevent the terminal from camping in another cell covered by the multicast cell and receiving a multicast service in the multicast cell, a paging message is sent to another overlapping or neighboring coverage cell of the multicast cell, or a cell located in an RNA range of the terminal in the foregoing cell.

In particular, in the paging message, a multicast update purpose may be further distinguished. Because a TMGI service identity is used for paging, it may be already indicated that the service changes. Therefore, only whether the configuration changes or the services end needs to be distinguished again. For example, the TMGI paging manner is used for the service change, and a special flag for the end of the service is carried on this basis. Because the service change is to perform connection resumption, which is basically consistent with behavior that common downlink data arrives at paging, the service may be directly released when ending, so as to avoid releasing after the connection resumption.

In the foregoing paging manner, if the terminal is still within a receiving range of the multicast cell or the valid range of the configuration, the terminal may receive a paging message about a TMGI that is of interest to the terminal, and a service end flag is used to indicate that this paging is performed for which the configuration of the multicast service changes or the service ends.

In addition, after receiving the paging, the terminal performs a corresponding response operation. If a purpose can be distinguished, different actions are taken based on different paging purposes. For example, if the service changes, the terminal needs to perform connection resumption to obtain latest configuration information from the network side, and if the service ends, a related bearer/configuration may be directly released, and even an idle state (Idle state) is entered after the bearer is released, thereby avoiding a cumbersome process of releasing after connection resumption. If the paging message does not carry additional information or terminals cannot be distinguished, a unified action of the terminals is to perform connection resumption to the network, and the network side performs judgment.

For the network side, if the connection resumption of the terminal is received, the network side may determine, from the UE ID, that this terminal is interested in the multicast service, and the network side is just ready to change the configuration of the multicast service or end the service. Therefore, in this case, the terminal restores a connection for the service, and the network side may perform at least one of the following:
sending, by the network side, an RRC release message to the terminal that initiates the connection resumption, where the message carries updated configuration information of the multicast service of interest to the terminal;
sending, by the network side, an RRC release message to the terminal that initiates the connection resumption, where in a case that all multicast services that the terminal is interested in end, the terminal is released to return to an idle state;
initiating, by the network side, a connection resume command to the terminal to enable the terminal to enter a connected state;
in a case that the terminal needs to send other uplink data, initiating, by the network side, a connection resume command to the terminal to enable the terminal to enter a connected state; and
after the terminal enters a connected state, receiving, by the network, a request of the terminal, and sending the updated configuration information of the multicast service to the terminal.

In a special case, if the paging message of the network side explicitly indicates that the multicast service ends, and the terminal receives this indication, a bearer and a configuration corresponding to multicast may be released. When the terminal has only one multicast service, the terminal may return to an idle state or remain in an inactive state. Correspondingly, if the terminal needs to return to an idle state, the network side also has a bearer context of the terminal, and corresponding bearer release and terminal release operations may be performed. It is equivalent to that the terminal and the network respectively complete releasing, thereby avoiding signaling interaction.

In this embodiment, in the UE ID manner, the paging message is sent based on the terminal list, and therefore there is no impact on the terminal in a connected state that receives a multicast service. In the TMGI manner, the terminal in a connected state does not monitor a paging occasion, and therefore the TMGI paging does not affect the terminal in a connected state that receives a multicast service.

In some implementations, the L1 signaling includes:
L1 signaling scheduled by a Group-Radio Network Temporary Identity (G-RNTI) corresponding to the multicast service.

The L1 signaling may include a Physical Downlink Control Channel (PDCCH), for example, a PDCCH corresponding to an MBS Traffic Channel (MTCH) of the multicast service. An information field in the PDCH may be used to indicate at least one of that the configuration of the multicast service changes and the multicast service ends. The information field may be a special information field, such as a reused information field defined in a protocol or a newly defined information field.

It should be noted that, in this embodiment of this application, the L1 signaling is not limited to the L1 signaling scheduled by the G-RNTI. For example, the L1 signaling may be L1 signaling scheduled by another RNTI, such as L1 signaling scheduled by a Multicast Radio Network Temporary Identity (Multicast-RNTI), L1 signaling scheduled by a Cell-Radio Network Temporary Identifier (C-RNTI), or L1 signaling scheduled by an RNTI newly defined in a subsequent protocol.

In some implementations, the L1 signaling includes a PDCCH, the PDCCH includes an indicator bit, and the indicator bit is used to indicate at least one of that the configuration of the multicast service changes and the multicast service ends; and
the indicator bit includes:
a bit defined in a protocol for the PDCCH; or
at least one bit newly defined for the PDCCH.

In this implementation, at least one of that the configuration of the multicast service changes and the multicast service ends may be indicated by reusing the defined bit, or at least one of that the configuration of the multicast service changes and the multicast service ends may be indicated by using the newly defined bit.

Another embodiment is as follows:

This embodiment mainly describes that at least one of that a configuration of a multicast service changes and the multicast service ends is indicated by using L1 signaling, which may be as follows:

A multicast cell needs to notify a terminal in a non-connected state that a configuration of a multicast service changes or the service ends due to a change of a situation. L1 signaling is also a feasible manner of notifying UE.

Because each multicast service has a configured G-RNTI, a PDCCH scrambled by using the G-RNTI is used to send scheduling information. In this case, 1-bit to 2-bit content may be added to a PDCCH format to indicate that a configuration changes and/or a service ends.

For example, in a broadcast service, there is a PDCCH scrambled by an MBS Control Channel Network Temporary Identity (MCCH-RNTI). In a PDCCH format, there is 2-bit content, where 1 bit represents arrival of a new service, and the other 1-bit content represents a change of an existing service, including a change of a configuration, an end of the configuration, or a change of neighboring cell information.

In this embodiment, the foregoing PDCCH format may be reused, and the 2-bit content is re-assigned to a new meaning, where 1 bit represents a change of a service configuration, and the other 1-bit content represents an end of an existing service. In some alternative embodiments, only 1 bit is uniformly used to indicate a change, including a change and an end.

For a terminal, each terminal interested in a multicast service monitors a PDCCH scrambled by a G-RNTI corresponding to the service. If new content of one of 2 bits in a PDCCH format is read, a corresponding action may be performed based on indicated content. For example:

When a service configuration changes, a connection resume request is initiated to a network.

If a service ends, a bearer/configuration corresponding to the service is released.

If no other service or bearer exists after the bearer of the service is released, the terminal may return to an idle state or remain in an inactive state.

For the network side, if the connection resumption of the terminal is received, the network side may determine, from the UE ID, that this terminal is interested in the multicast service, and the network side is just ready to change the configuration of the multicast service or end the service. Therefore, in this case, the terminal restores a connection for the service, and the network side may perform at least one of the following:
sending, by the network side, an RRC release message to the terminal that initiates the connection resumption, where the message carries updated configuration information of the multicast service of interest to the terminal;
sending, by the network side, an RRC release message to the terminal that initiates the connection resumption, where in a case that all multicast services that the terminal is interested in end, the terminal is released to return to an idle state;
initiating, by the network side, a connection resume command to the terminal to enable the terminal to enter a connected state;
in a case that the terminal needs to send other uplink data, initiating, by the network side, a connection resume command to the terminal to enable the terminal to enter a connected state; and
after the terminal enters a connected state, receiving, by the network, a request of the terminal, and sending the updated configuration information of the multicast service to the terminal.

In the L1 signaling manner, because different terminal states cannot be distinguished from each other, a terminal in a connected state may also receive a multicast service. If a lower-version terminal does not perform parsing, there is no impact, and if a higher-version terminal may perform decoding without any operation, dedicated control signaling on the network side needs to be waited.

In an implementation, the MAC signaling includes:

MAC signaling scheduled by a G-RNTI corresponding to the multicast service.

The MAC signaling may be a Media Access Control Control Element (MAC CE).

In this implementation, the MAC signaling scheduled by the G-RNTI may carry more information, for example, may further carry a service identity of the multimedia service.

It should be noted that, in this embodiment of this application, the MAC signaling is not limited to the MAC signaling scheduled by the G-RNTI. For example, the MAC signaling may be MAC signaling scheduled by another RNTI, such as MAC signaling scheduled by a multicast-RNTI, MAC signaling scheduled by a C-RNTI, or MAC signaling scheduled by an RNTI newly defined in a subsequent protocol.

In some implementations, the MAC signaling is further used to indicate a service identity of the multicast service.

The service identity of the multicast service may include at least one of the following:
a TMGI, a TMGI index, and an MRB ID list.

In this implementation, the service identity is indicated, so that more accurate notification can be implemented.

An embodiment is as follows:

This embodiment mainly describes that a terminal is notified by using MAC signaling, which may be as follows:

A multicast cell needs to notify a terminal in a non-connected state that a configuration of a multicast service changes or the service ends due to a change of a situation. MAC signaling is also a feasible manner of notifying a terminal.

The MAC signaling may be in a form of a MAC CE. The MAC signaling may carry more information than L1 signaling, and a format of the MAC CE may be relatively large. For example, in addition to carrying a service change indication and/or a service end indication, the MAC signaling may further carry corresponding service identity information, such as a TMGI, or a TMGI index, or an MRB ID list. The MAC CE may also be sent in a G-RNTI scheduling manner, and is generally reused with a data service for sending. In some communication systems, in a design of a multicast service, each service TMGI corresponds to one G-RNTI for scheduling, but in turn, the network side may allocate a same G-RNTI to a plurality of TMGIs, that is, data scheduled by a same G-RNTI may belong to different TMGIs and different services. Therefore, the MAC CE explicitly indicates which service changes or ends, which is also advantageous to the terminal, so that the terminal can better determine whether a change of interest to the terminal has occurred, thereby taking a related action.

For a terminal, each terminal interested in a multicast service monitors scheduling and data corresponding to a G-RNTI corresponding to the service. If a related MAC CE is read from the data, a corresponding action may be performed based on indicated content of the MAC CE. For example, at least one of the following is performed:

When a service configuration changes, a connection resume request is initiated to a network.

If a service ends, a bearer corresponding to the service is released.

If no other service or bearer exists after the bearer of the service is released, the terminal may return to an idle state.

For behavior and a subsequent operation of the network side, refer to the corresponding content in the foregoing plurality of embodiments and implementations.

In the MAC signaling manner, because different terminal states cannot be distinguished from each other, a terminal in a connected state may also receive a multicast service. If a lower-version terminal does not know that the MAC CE and directly discards the MAC CE, there is no impact, and if a higher-version terminal may perform decoding without any operation, dedicated control signaling on the network side needs to be waited.

In an implementation, the common signaling includes:
common signaling scheduled by a multicast-RNTI corresponding to the multicast service, where the multicast-RNTI is the same as or different from a G-RNTI corresponding to the multicast service.

The common signaling may be Layer 3 (L3) signaling, Layer 2 (L2) signaling, or L1 signaling.

It should be noted that, in this embodiment of this application, the common signaling is not limited to the common signaling scheduled by the multicast-RNTI. For example, the common signaling may be MAC signaling scheduled by another RNTI, such as common signaling scheduled by a G-RNTI, common signaling scheduled by a C-RNTI, or common signaling scheduled by an RNTI newly defined in a subsequent protocol.

In some implementations, the common signaling carries at least one of the following:
a service identity of the multicast service, a change flag indicating that the configuration of the multicast service changes, an end flag indicating that the multicast service ends, a changed new configuration of the multicast service, and effective time information of the changed new configuration of the multicast service.

At least one of that the configuration of the multicast service changes and the multicast service ends may be explicitly or implicitly indicated by using the content carried above. For example, when the service identity of the multicast service is carried, the service identity may be used to implicitly indicate at least one of that the configuration of the multicast service changes and the multicast service ends. When the changed new configuration of the multicast service and the effective time information of the changed new configuration of the multicast service are carried, that the configuration of the multicast service changes may be implicitly indicated.

In addition, precise notification can be implemented by using the service identity of the multicast service, a new configuration can be quickly delivered by using the changed new configuration of the multicast service, and an effective time of the configuration can be accurately controlled by using the effective time information of the changed new configuration of the multicast service.

An embodiment is as follows:

This embodiment mainly describes common signaling, which is as follows:

A multicast cell needs to notify a terminal in a non-connected state that a configuration of a multicast service changes or the service ends due to a change of a situation. Common signaling is also a feasible manner of notifying a terminal.

In the common signaling manner, there may be a more flexible design. For example, a special multicast-RNTI dedicated to common signaling may be allocated to a group of terminals, so as to schedule a notification message about a multicast change. The notification message may also be configured with a time domain pattern, that is, a period length, a repetition quantity, or the like, or may be configured with a corresponding frequency domain resource, dynamic scheduling information, or the like.

A format of the notification message may be L3 signaling, L2 signaling, or L1 signaling. In this example, L3 signaling is used as an example. Because L2 signaling may refer to the design of the MAC CE described in the foregoing embodiment, and L1 signaling may refer to the design of the PDCCH format described in the foregoing embodiment, a difference of the L1 and L2 signaling between this embodiment and the foregoing embodiment is that an independent RNTI may be configured, and a G-RNTI is not reused, or a new time domain and/or frequency domain configuration may be configured, and a configuration limitation of the G-RNTI is no longer followed.

The common L3 signaling may be designed as a multicast control message modification message carrying a service identity, such as a TMGI, and/or a change flag, and/or an end flag, and even may directly carry a changed new configuration of a multicast service, effective time information of the new configuration, and the like.

For a terminal, each terminal interested in a multicast service monitors common signaling scheduling and data corresponding to the service. If related indicated content is read, a corresponding action is performed. For example:

When a service configuration changes, a connection resume request is initiated to a network.

If a service ends, a bearer corresponding to the service is released.

If no other service or bearer exists after the bearer of the service is released, the terminal may return to an idle state.

If the changed new configuration is read directly, the new configuration is used immediately or based on the effective time information to receive the service.

For behavior and a subsequent operation of the network side, refer to the corresponding content in the foregoing embodiments and implementations.

In the common signaling manner, only a terminal in an inactive state may be required to read the common signaling. Therefore, there may be no impact on a terminal in a connected state that receives a multicast service.

In an implementation, the RRC message includes:
an RRC message scheduled by a G-RNTI corresponding to the multicast service.

The RRC message may be an RRC message that supports an Acknowledged Mode (AM).

In this implementation, because notification is performed by using an RRC message, reliability of the notification can be improved.

It should be noted that, in this embodiment of this application, the RRC message is not limited to the common signaling scheduled by the G-RNTI. For example, the RRC message may be common signaling scheduled by another RNTI, for example, common signaling scheduled by a multicast-RNTI, common signaling scheduled by a C-RNTI, or common signaling scheduled by an RNTI newly defined in a subsequent protocol.

In this embodiment of this application, the foregoing plurality of signaling messages may be implemented in combination with each other. For example:

A change of a multicast service is sent by using a paging message, and an end of the multicast service is sent by using a MAC CE.

A change of a multicast service is sent by using L1 signaling, and an end of the multicast service is sent by using a MAC CE.

A change of a multicast service is sent by using common signaling, and an end of the multicast service is sent by using a MAC CE.

For example, one of a paging message, L1 signaling, medium access control MAC signaling, a radio resource control RRC message, and common signaling may be used to send the change of the multicast service, and the end of the multicast service is sent in another manner.

In this embodiment of this application, a terminal receives a first notification, where the first notification is used to notify at least one of that a configuration of a multicast service changes and the multicast service ends, where the multicast service is a multicast service that is being received by the terminal; and executing, by the terminal, a response operation of the first notification. In this way, the terminal can learn at least one of that the configuration of the multicast service changes and the multicast service ends, thereby improving an effect of receiving the multicast service by the terminal.

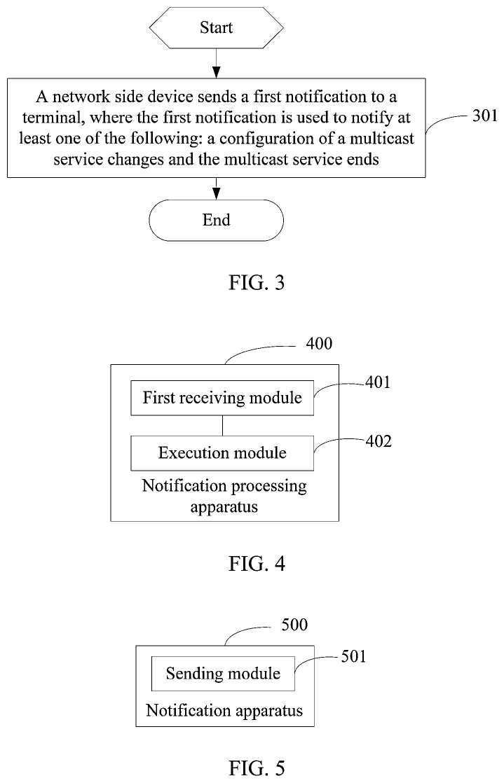

Referring to FIG. 3, FIG. 3 is a flowchart of a notification method according to an embodiment of this application. As shown in FIG. 3, the method includes the following steps:

301. A network side device sends a first notification to a terminal, where the first notification is used to notify at least one of that a configuration of a multicast service changes and the multicast service ends, where the multicast service is a multicast service that is being received by the terminal, and that the multicast service ends includes at least one of the following: sending of the multicast service ends or receiving of the multicast service ends.

In some embodiments, the first notification includes at least one of the following:
a paging message, layer 1 L1 signaling, medium access control MAC signaling, a radio resource control RRC message, and common signaling.

In some embodiments, the paging message includes at least one of the following:
a first paging message that carries a terminal identifier; and
a second paging message that carries a temporary mobile group identity.

In some embodiments, the L1 signaling includes:
L1 signaling scheduled by a group radio network temporary identity G-RNTI corresponding to the multicast service.

In some embodiments, the L1 signaling includes a physical downlink control channel PDCCH, the PDCCH includes an indicator bit, and the indicator bit is used to indicate at least one of that the configuration of the multicast service changes and the multicast service ends; and
the indicator bit includes:
a bit defined in a protocol for the PDCCH; or
at least one bit newly defined for the PDCCH.

In some embodiments, the MAC signaling includes:

MAC signaling scheduled by a G-RNTI corresponding to the multicast service.

In some embodiments, the MAC signaling is further used to indicate a service identity of the multicast service.

In some embodiments, the common signaling includes:
common signaling scheduled by a multicast radio network temporary identity Multicast-RNTI corresponding to the multicast service, where the Multicast-RNTI is the same as or different from a G-RNTI corresponding to the multicast service.

In some embodiments, the common signaling carries one of the following:
a service identity of the multicast service, a change flag indicating that the configuration of the multicast service changes, an end flag indicating that the multicast service ends, a changed new configuration of the multicast service, and effective time information of the changed new configuration of the multicast service.

In some embodiments, the RRC message includes:
an RRC message scheduled by a G-RNTI corresponding to the multicast service.

In some embodiments, the method further includes at least one of the following:
receiving, by the network side device, a connection resume request sent by the terminal;
receiving, by the network side device, a request that is sent by the terminal and that is used to request the changed new configuration of the multicast service; and
releasing, by the network side device, the multicast service.

In some embodiments, after the receiving, by the network side device, a connection resume request sent by the terminal, the method further includes at least one of the following:
sending, by the network side device, a connection resume message to the terminal;
sending, by the network side device, a radio resource control RRC release message to the terminal; and
sending, by the network side device, the changed new configuration of the multicast service to the terminal.

In some embodiments, in a case that the first notification indicates that the configuration of the multicast service changes, the RRC release message carries the changed new configuration of the multicast service.

It should be noted that this embodiment is used as an implementation of the network side device corresponding to the embodiment shown in FIG. 2. For an implementation of this embodiment, refer to the related descriptions of the embodiment shown in FIG. 2. To avoid repetition, details are not described in this embodiment again.

Referring to FIG. 4, FIG. 4 is a structural diagram of a notification processing apparatus according to an embodiment of this application. As shown in FIG. 4, a notification processing apparatus 400 includes:
a first receiving module 401, configured to receive a first notification, where the first notification is used to notify at least one of that a configuration of a multicast service changes and the multicast service ends, where the multicast service is a multicast service that is being received by a terminal, and that the multicast service ends includes at least one of the following: sending of the multicast service ends or receiving of the multicast service ends; and
an execution module 402, configured to execute a response operation of the first notification.

In some embodiments, the first notification includes at least one of the following:
a paging message, layer 1 L1 signaling, medium access control MAC signaling, a radio resource control RRC message, and common signaling.

In some embodiments, the paging message includes at least one of the following:
a first paging message that carries a terminal identifier; and
a second paging message that carries a temporary mobile group identity.

In some embodiments, the L1 signaling includes:

L1 signaling scheduled by a group radio network temporary identity G-RNTI corresponding to the multicast service.

In some embodiments, the L1 signaling includes a physical downlink control channel PDCCH, the PDCCH includes an indicator bit, and the indicator bit is used to indicate at least one of that the configuration of the multicast service changes and the multicast service ends; and
the indicator bit includes:
a bit defined in a protocol for the PDCCH; or
at least one bit newly defined for the PDCCH.

In some embodiments, the MAC signaling includes:

MAC signaling scheduled by a G-RNTI corresponding to the multicast service.

In some embodiments, the MAC signaling is further used to indicate a service identity of the multicast service.

In some embodiments, the common signaling includes:
common signaling scheduled by a multicast radio network temporary identity Multicast-RNTI corresponding to the multicast service, where the Multicast-RNTI is the same as or different from a G-RNTI corresponding to the multicast service.

In some embodiments, the common signaling carries at least one of the following:
a service identity of the multicast service, a change flag indicating that the configuration of the multicast service changes, an end flag indicating that the multicast service ends, a changed new configuration of the multicast service, and effective time information of the changed new configuration of the multicast service.

In some embodiments, the RRC message includes:
an RRC message scheduled by a G-RNTI corresponding to the multicast service.

In some embodiments, the response operation includes at least one of the following:
initiating connection resumption to a network side device;
requesting the changed new configuration of the multicast service from the network side device;
receiving the changed new configuration that is of the multicast service and that is sent to the network side device;
releasing the multicast service;
releasing to an idle state; and
remaining in an inactive state.

In some embodiments, in a case that the first notification indicates that the configuration of the multicast service changes, the response operation includes at least one of the following:
initiating connection resumption to the network side device;
requesting the changed new configuration of the multicast service from the network side device;
receiving the changed new configuration that is of the multicast service and that is sent to the network side device; and
remaining in an inactive state;
and/or
in a case that the first notification indicates that the multicast service ends, the response operation includes at least one of the following:
releasing the multicast service;
releasing to an idle state; and
remaining in an inactive state.

In some embodiments, the apparatus further includes at least one of the following:
a second receiving module, configured to receive a connection resume message;
a third receiving module, configured to receive a radio resource control RRC release message; and
a fourth receiving module, configured to receive the changed new configuration of the multicast service.

In some embodiments, in a case that the first notification indicates that the configuration of the multicast service changes, the RRC release message carries the changed new configuration of the multicast service.

In some embodiments, the multicast service is a multicast service that is being received by the terminal in an inactive state.

The foregoing notification processing apparatus can improve an effect of receiving the multicast service by the terminal.

The notification processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the listed types of the terminal in this embodiment of this application, and the another device may be a server, a Network Attached Storage (NAS), or the like. This is not specifically limited in this embodiment of this application.

The notification processing apparatus provided in this embodiment of this application can implement the processes implemented in the method embodiment shown in FIG. 2, and achieve a same technical effect. To avoid repetition, details are not described herein again.

Referring to FIG. 5, FIG. 5 is a structural diagram of a notification apparatus according to an embodiment of this application. As shown in FIG. 5, the notification apparatus 500 includes: a first sending module 501, configured to send a first notification to a terminal, where
the first notification is used to notify at least one of that a configuration of a multicast service changes and the multicast service ends, where the multicast service is a multicast service that is being received by the terminal, and that the multicast service ends includes at least one of the following: sending of the multicast service ends or receiving of the multicast service ends.

In some embodiments, the first notification includes at least one of the following:
a paging message, layer 1 L1 signaling, medium access control MAC signaling, a radio resource control RRC message, and common signaling.

In some embodiments, the paging message includes at least one of the following:
a first paging message that carries a terminal identifier; and
a second paging message that carries a temporary mobile group identity.

In some embodiments, the L1 signaling includes:
L1 signaling scheduled by a group radio network temporary identity G-RNTI corresponding to the multicast service.

In some embodiments, the L1 signaling includes a physical downlink control channel PDCCH, the PDCCH includes an indicator bit, and the indicator bit is used to indicate at least one of that the configuration of the multicast service changes and the multicast service ends; and
the indicator bit includes:
a bit defined in a protocol for the PDCCH; or
at least one bit newly defined for the PDCCH.

In some embodiments, the MAC signaling includes:

MAC signaling scheduled by a G-RNTI corresponding to the multicast service.

In some embodiments, the MAC signaling is further used to indicate a service identity of the multicast service.

In some embodiments, the common signaling includes:
common signaling scheduled by a multicast radio network temporary identity Multicast-RNTI corresponding to the multicast service, where the Multicast-RNTI is the same as or different from a G-RNTI corresponding to the multicast service.

In some embodiments, the common signaling carries one of the following:
a service identity of the multicast service, a change flag indicating that the configuration of the multicast service changes, an end flag indicating that the multicast service ends, a changed new configuration of the multicast service, and effective time information of the changed new configuration of the multicast service.

In some embodiments, the RRC message includes:
an RRC message scheduled by a G-RNTI corresponding to the multicast service.

In some embodiments, the apparatus further includes at least one of the following:
a first receiving module, configured to receive a connection resume request sent by the terminal;
a second receiving module, configured to receive a request that is sent by the terminal and that is used to request the changed new configuration of the multicast service; and
a release module, configured to release the multicast service.

In some embodiments, the apparatus further includes at least one of the following:
a second sending module, configured to send a connection resume message to the terminal;
a third sending module, configured to send a radio resource control RRC release message to the terminal; and
a fourth sending module, configured to send the changed new configuration of the multicast service to the terminal.

In some embodiments, in a case that the first notification indicates that the configuration of the multicast service changes, the RRC release message carries the changed new configuration of the multicast service.

The foregoing notification apparatus can improve an effect of receiving the multicast service by the terminal.

The notification apparatus in this embodiment of this application may be an electronic device, for example, an electronic device with an operating system, or may be a component in the electronic device, for example, an integrated circuit or a chip. The electronic device may be a network side device.

The notification apparatus provided in this embodiment of this application can implement the processes implemented in the method embodiment shown in FIG. 3, and achieve a same technical effect. To avoid repetition, details are not described herein again.

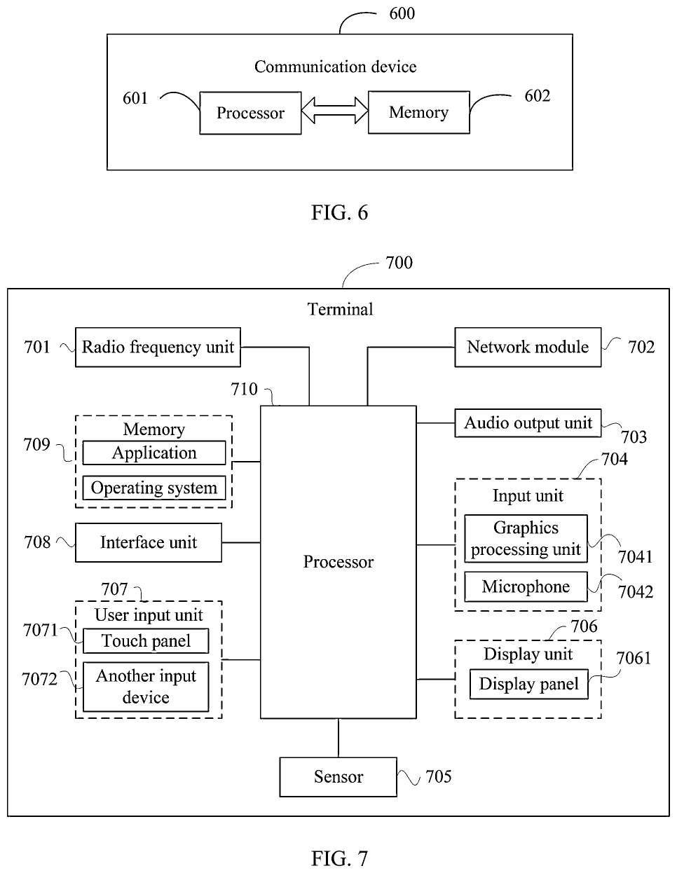

In some embodiments, as shown in FIG. 6, an embodiment of this application further provides a communication device 600, including a processor 601 and a memory 602. The memory 602 stores a program or an instruction that can be run on the processor 601. For example, when the communication device 600 is a terminal, the program or the instruction is executed by the processor 601 to implement the steps of the foregoing notification processing method embodiment, and a same technical effect can be achieved. When the communication device 600 is a network side device, the program or the instruction is executed by the processor 601 to implement the processes of the foregoing notification method embodiment, and a same technical effect can be achieved. To avoid repetition, details are not described herein again.

An embodiment of this application further provides a terminal, including a processor and a communication interface. The communication interface is configured to receive a first notification, where the first notification is used to notify at least one of that a configuration of a multicast service changes and the multicast service ends, where the multicast service is a multicast service that is being received by the terminal, and that the multicast service ends includes at least one of the following: sending of the multicast service ends or receiving of the multicast service ends; and the processor or the communication interface is configured to execute a response operation of the first notification. This terminal embodiment corresponds to the foregoing method embodiment on the terminal side, each implementation process and implementation of the foregoing method embodiment can be applied to this terminal embodiment, and a same technical effect can be achieved. For example, FIG. 7 is a schematic structural diagram of hardware of a terminal according to an embodiment of this application.

The terminal 700 includes but is not limited to components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include the power supply (for example, a battery) that supplies power to each component. The power supply may be logically connected to the processor 710 by using a power supply management system, so as to manage functions such as charging, discharging, and power consumption by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 704 may include a Graphics Processing Unit (GPU) 7041 and a microphone 7042, and the graphics processing unit 7041 processes image data of a still image or a video that is obtained by an image capturing apparatus (for example, a camera) in a video capturing mode or an image capturing mode. The display unit 706 may include a display panel 7061. The display panel 7061 may be configured in a form such as a liquid crystal display or an organic light-emitting diode. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 709 in this embodiment of this application includes but is not limited to these memories and a memory of any other proper type.

The processor 710 may include one or more processing units. In some embodiments, an application processor and a modem processor are integrated into the processor 710. The application processor mainly processes an operating system, a user interface, an application, and the like. The modem processor mainly processes a wireless communication signal, for example, a baseband processor. It can be understood that, in some alternative embodiments, the modem processor may not be integrated into the processor 710.

The radio frequency unit 701 is configured to receive a first notification, where the first notification is used to notify at least one of that a configuration of a multicast service changes and the multicast service ends, where the multicast service is a multicast service that is being received by the terminal, and that the multicast service ends includes at least one of the following: sending of the multicast service ends or receiving of the multicast service ends.

The processor 710 or the radio frequency unit 701 is configured to execute a response operation of the first notification.

In some embodiments, the first notification includes at least one of the following:
a paging message, layer 1 L1 signaling, medium access control MAC signaling, a radio resource control RRC message, and common signaling.

In some embodiments, the paging message includes at least one of the following:
a first paging message that carries a terminal identifier; and
a second paging message that carries a temporary mobile group identity.

In some embodiments, the L1 signaling includes:
L1 signaling scheduled by a group radio network temporary identity G-RNTI corresponding to the multicast service.

In some embodiments, the L1 signaling includes a physical downlink control channel PDCCH, the PDCCH includes an indicator bit, and the indicator bit is used to indicate at least one of that the configuration of the multicast service changes and the multicast service ends; and
the indicator bit includes:
a bit defined in a protocol for the PDCCH; or
at least one bit newly defined for the PDCCH.

In some embodiments, the MAC signaling includes:

MAC signaling scheduled by a G-RNTI corresponding to the multicast service.

In some embodiments, the MAC signaling is further used to indicate a service identity of the multicast service.

In some embodiments, the common signaling includes:
common signaling scheduled by a multicast radio network temporary identity Multicast-RNTI corresponding to the multicast service, where the Multicast-RNTI is the same as or different from a G-RNTI corresponding to the multicast service.

In some embodiments, the common signaling carries at least one of the following:
a service identity of the multicast service, a change flag indicating that the configuration of the multicast service changes, an end flag indicating that the multicast service ends, a changed new configuration of the multicast service, and effective time information of the changed new configuration of the multicast service.

In some embodiments, the RRC message includes:
an RRC message scheduled by a G-RNTI corresponding to the multicast service.

In some embodiments, the response operation includes at least one of the following:
initiating connection resumption to a network side device;
requesting the changed new configuration of the multicast service from the network side device;
receiving the changed new configuration that is of the multicast service and that is sent to the network side device;
releasing the multicast service;
releasing to an idle state; and
remaining in an inactive state.

In some embodiments, in a case that the first notification indicates that the configuration of the multicast service changes, the response operation includes at least one of the following:
initiating connection resumption to the network side device;
requesting the changed new configuration of the multicast service from the network side device;
receiving the changed new configuration that is of the multicast service and that is sent to the network side device; and
remaining in an inactive state;
and/or
in a case that the first notification indicates that the multicast service ends, the response operation includes at least one of the following:
releasing the multicast service;
releasing to an idle state; and
remaining in an inactive state.

In some embodiments, the radio frequency unit 701 is further configured to:
receive a connection resume message;
receive a radio resource control RRC release message; and
receive the changed new configuration of the multicast service.

In some embodiments, in a case that the first notification indicates that the configuration of the multicast service changes, the RRC release message carries the changed new configuration of the multicast service.

In some embodiments, the multicast service is a multicast service that is being received by the terminal in an inactive state.

The foregoing terminal can improve an effect of receiving the multicast service by the terminal.

An embodiment of this application further provides a network side device, including a processor and a communication interface. The communication interface is configured to send a first notification to a terminal, where the first notification is used to notify at least one of that a configuration of a multicast service changes and the multicast service ends, where the multicast service is a multicast service that is being received by the terminal, and that the multicast service ends includes at least one of the following: sending of the multicast service ends or receiving of the multicast service ends. This network side device embodiment corresponds to the foregoing method embodiment on the network side device side, each implementation process and implementation of the foregoing method embodiment can be applied to this network side device embodiment, and a same technical effect can be achieved.

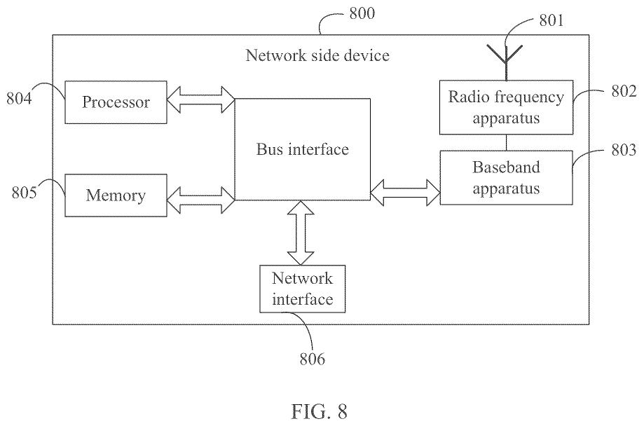

An embodiment of this application further provides a network side device. As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information by using the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information by using the antenna 801.

In the foregoing embodiment, the method performed by the network side device may be implemented in the baseband apparatus 803. The baseband apparatus 803 includes a baseband processor.

The baseband apparatus 803 may include, for example, at least one baseband board, where a plurality of chips are disposed on the baseband board. As shown in FIG. 8, one chip is, for example, the baseband processor, is connected to the memory 805 through a bus interface, to invoke a program in the memory 805 to perform the operations of the network device shown in the foregoing method embodiment.

The network side device may further include a network interface 806, and the interface is, for example, a Common Public Radio Interface (CPRI).

For example, the network side device 800 in this embodiment of the present disclosure further includes an instruction or a program that is stored in the memory 805 and that can be run on the processor 804. The processor 804 invokes the instruction or the program in the memory 805 to perform the method performed by the modules shown in FIG. 5, and a same technical effect is achieved. To avoid repetition, details are not described herein again.

The radio frequency apparatus 802 is configured to send a first notification to a terminal, where the first notification is used to notify at least one of that a configuration of a multicast service changes and the multicast service ends, where the multicast service is a multicast service that is being received by the terminal, and that the multicast service ends includes at least one of the following: sending of the multicast service ends or receiving of the multicast service ends.

In some embodiments, the first notification includes at least one of the following:
a paging message, layer 1 L1 signaling, medium access control MAC signaling, a radio resource control RRC message, and common signaling.

In some embodiments, the paging message includes at least one of the following:
a first paging message that carries a terminal identifier; and
a second paging message that carries a temporary mobile group identity.

In some embodiments, the L1 signaling includes:
L1 signaling scheduled by a group radio network temporary identity G-RNTI corresponding to the multicast service.

In some embodiments, the L1 signaling includes a physical downlink control channel PDCCH, the PDCCH includes an indicator bit, and the indicator bit is used to indicate at least one of that the configuration of the multicast service changes and the multicast service ends; and
the indicator bit includes:
a bit defined in a protocol for the PDCCH; or
at least one bit newly defined for the PDCCH.

In some embodiments, the MAC signaling includes:

MAC signaling scheduled by a G-RNTI corresponding to the multicast service.

In some embodiments, the MAC signaling is further used to indicate a service identity of the multicast service.

In some embodiments, the common signaling includes:
common signaling scheduled by a multicast radio network temporary identity Multicast-RNTI corresponding to the multicast service, where the Multicast-RNTI is the same as or different from a G-RNTI corresponding to the multicast service.

In some embodiments, the common signaling carries one of the following:
a service identity of the multicast service, a change flag indicating that the configuration of the multicast service changes, an end flag indicating that the multicast service ends, a changed new configuration of the multicast service, and effective time information of the changed new configuration of the multicast service.

In some embodiments, the RRC message includes:
an RRC message scheduled by a G-RNTI corresponding to the multicast service.

In some embodiments, the radio frequency apparatus 802 is further configured to:
receive a connection resume request sent by the terminal;
receive a request that is sent by the terminal and that is used to request the changed new configuration of the multicast service; and
release the multicast service.

In some embodiments, the radio frequency apparatus 802 is further configured to:
send a connection resume message to the terminal;
send a radio resource control RRC release message to the terminal; and
send the changed new configuration of the multicast service to the terminal.

In some embodiments, in a case that the first notification indicates that the configuration of the multicast service changes, the RRC release message carries the changed new configuration of the multicast service.

The foregoing network side device can improve an effect of receiving the multicast service by the terminal.

An embodiment of this application further provides a readable storage medium. The readable storage medium stores a program or an instruction, and the program or the instruction is executed by a processor to implement the steps of the notification processing method or the notification method provided in the embodiments of this application.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing notification processing method or notification method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing notification processing method or notification method embodiment, and a same technical effect can be achieved. To avoid repetition, details are not described herein again.

An embodiment of this application further provides a wireless communication system, including a terminal and a network side device. The terminal may be configured to perform the steps of the notification processing method provided in the embodiments of this application, and the network side device may be configured to perform the steps of the notification method provided in the embodiments of this application.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In some embodiments, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above implementations, and the above implementations are merely illustrative but not restrictive. Under the enlightenment of this application, a person of ordinary skill in the art can make many forms without departing from the purpose of this application and the protection scope of the claims, all of which fall within the protection of this application.

1. A notification processing method, comprising:
receiving, by a terminal, a first notification, wherein the first notification is used to notify at least one of that a configuration of a multicast service changes or the multicast service ends, wherein the multicast service is a multicast service that is being received by the terminal, and that the multicast service ends comprises at least one of the following: sending of the multicast service ends or receiving of the multicast service ends; and
executing, by the terminal, a response operation of the first notification.

2. The notification processing method according to claim 1, wherein the first notification comprises at least one of the following:
a paging message, Layer 1 (L1) signaling, Medium Access Control (MAC) signaling, a Radio Resource Control (RRC) message, or common signaling.

3. The notification processing method according to claim 2, wherein the paging message comprises at least one of the following:
a first paging message that carries a terminal identifier; or
a second paging message that carries a temporary mobile group identity.

4. The notification processing method according to claim 2, wherein the L1 signaling comprises:
L1 signaling scheduled by a Group Radio Network Temporary Identity (G-RNTI) corresponding to the multicast service.

5. The notification processing method according to claim 2, wherein the L1 signaling comprises a Physical Downlink Control Channel (PDCCH), wherein the PDCCH comprises an indicator bit,
wherein:
the indicator bit is used to indicate at least one of that the configuration of the multicast service changes or the multicast service ends; and
the indicator bit comprises:
a bit defined in a protocol for the PDCCH, or
at least one bit newly defined for the PDCCH.

6. The notification processing method according to claim 2, wherein the MAC signaling comprises:
MAC signaling scheduled by a Group Radio Network Temporary Identity (G-RNTI) corresponding to the multicast service.

7. The notification processing method according to claim 2, wherein the MAC signaling is further used to indicate a service identity of the multicast service.

8. The notification processing method according to claim 2, wherein the common signaling comprises:
common signaling scheduled by a Multicast Radio Network Temporary Identity (Multicast-RNTI) corresponding to the multicast service, wherein the Multicast-RNTI is the same as or different from a Group Radio Network Temporary Identity (G-RNTI) corresponding to the multicast service.

9. The notification processing method according to claim 2, wherein the common signaling carries at least one of the following:
a service identity of the multicast service, a change flag indicating that the configuration of the multicast service changes, an end flag indicating that the multicast service ends, a changed new configuration of the multicast service, or effective time information of the changed new configuration of the multicast service.

10. The notification processing method according to claim 2, wherein the RRC message comprises:
an RRC message scheduled by a Group Radio Network Temporary Identity (G-RNTI) corresponding to the multicast service.

11. The notification processing method according to claim 1, wherein the response operation comprises at least one of the following:
initiating connection resumption to a network side device;
requesting the changed new configuration of the multicast service from the network side device;
receiving the changed new configuration that is of the multicast service and that is sent to the network side device;
releasing the multicast service;
releasing to an idle state; or
remaining in an inactive state.

12. The notification processing method according to claim 11,
wherein:
when the first notification indicates that the configuration of the multicast service changes, the response operation comprises at least one of the following:
initiating connection resumption to the network side device;
requesting the changed new configuration of the multicast service from the network side device;
receiving the changed new configuration that is of the multicast service and that is sent to the network side device; or
remaining in an inactive state,
or
when the first notification indicates that the multicast service ends, the response operation comprises at least one of the following:
releasing the multicast service;
releasing to an idle state; or
remaining in an inactive state.

13. A notification method, comprising:
sending, by a network side device, a first notification to a terminal, wherein the first notification is used to notify at least one of that a configuration of a multicast service changes or the multicast service ends, wherein the multicast service is a multicast service that is being received by the terminal, and that the multicast service ends comprises at least one of the following: sending of the multicast service ends or receiving of the multicast service ends.

14. The notification method according to claim 13, wherein the first notification comprises at least one of the following:
a paging message, Layer 1 (L1) signaling, Medium Access Control (MAC) signaling, a Radio Resource Control (RRC) message, or common signaling.

15. The notification method according to claim 14, wherein the L1 signaling comprises a Physical Downlink Control Channel (PDCCH), wherein the PDCCH comprises an indicator bit,
wherein:
the indicator bit is used to indicate at least one of that the configuration of the multicast service changes or the multicast service ends; and
the indicator bit comprises:
a bit defined in a protocol for the PDCCH, or
at least one bit newly defined for the PDCCH.

16. The notification method according to claim 14, wherein the common signaling comprises:
common signaling scheduled by a Multicast Radio Network Temporary Identity (Multicast-RNTI) corresponding to the multicast service, wherein the Multicast-RNTI is the same as or different from a Group Radio Network Temporary Identity (G-RNTI) corresponding to the multicast service.

17. The notification method according to claim 13, further comprising:
receiving, by the network side device, a connection resume request sent by the terminal;
receiving, by the network side device, a request that is sent by the terminal and that is used to request the changed new configuration of the multicast service; or
releasing, by the network side device, the multicast service.

18. A terminal, comprising: a processor; and a memory having a computer program or an instruction stored thereon, wherein the computer program or the instruction, when executed by the processor, causes the processor to implement operations comprising:
receiving a first notification, wherein the first notification is used to notify at least one of that a configuration of a multicast service changes or the multicast service ends, wherein the multicast service is a multicast service that is being received, and that the multicast service ends comprises at least one of the following: sending of the multicast service ends or receiving of the multicast service ends; and
executing a response operation of the first notification.

19. The terminal according to claim 18, wherein the first notification comprises at least one of the following:
a paging message, Layer 1 (L1) signaling, Medium Access Control (MAC) signaling, a Radio Resource Control (RRC) message, or common signaling.

20. A network side device, comprising: a processor; and a memory having a computer program or an instruction stored thereon, wherein the computer program or the instruction, when executed by the processor, causes the processor to implement the notification method of claim 13.
